(19) United States
(12) Patent Application Publication
(10) Pub. No.: US 2021/0239788 A1
(43) Pub. Date: Aug. 5, 2021

(54) RADAR WITH VIRTUAL PLANAR ARRAY (VPA) ANTENNA

(71) Applicant: Alps Alpine Co., Ltd., Tokyo (JP)

(72) Inventors: Alebel H. ARAGE, Lake Orion, MI (US); Prabin SHRESTHA, Auburn Hills, MI (US); Tomotaka SUZUKI, Osaki-city (JP)

(21) Appl. No.: 16/782,832

(22) Filed: Feb. 5, 2020

(51) Int. Cl. G01S 7/03; G01S 13/931; H01Q 21/06

(52) U.S. Cl. CPC G01S 7/032; G01S 2013/0263; H01Q 21/065; G01S 13/931

(57) ABSTRACT

A radar sensor system includes an antenna module configured to generate an array of real signal measurements that correspond to signals transmitted from first antennas arranged on the antenna module, reflected from an object in the environment, and received by second antennas arranged on the antenna module, and a virtual array (VA) estimation module configured to generate a VA including the real signal measurements and a plurality of virtual signal measurements that correspond to locations in the VA between the real signal measurements and generate, based on the VA, detection data indicative of the object in the environment.

### FIELD

The present disclosure relates to radar sensors for vehicle safety and autonomous vehicles.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Vehicles may include one or more different type of sensors that sense vehicle surroundings. In some examples, signals received from the sensors may be processed and provided as inputs to autonomous driving systems. Autonomous vehicles are configured to travel on roadways in accordance with data collected and processed via the sensors and/or additional data including, but not limited to, data from a global positioning system, driver inputs, data received from other vehicles, etc. In other examples, the signals received from the sensors may be provided as inputs to systems configured to alert drivers about objects detected in the vehicle surroundings. The sensors are arranged on an exterior and/or interior of the vehicle to sense objects such as other vehicles, road infrastructure and/or road hazards, lane markings, traffic signs and lights, etc.

One example of a sensor that senses vehicle surroundings includes a radar sensor. Radar sensors may be configured to operate at micrometer (μm) and millimeter (mm) wave frequency bands providing sufficient resolution for object detection and parameter (e.g., kinematic quantities) measurement. Example frequency bands include, but not limited to, 24 GHz, 77 GHz, 79 GHz, and other higher millimeter frequency bands.

### SUMMARY

A radar sensor system includes an antenna module configured to generate an array of real signal measurements that correspond to signals transmitted from first antennas arranged on the antenna module, reflected from an object in the environment, and received by second antennas arranged on the antenna module, and a virtual array (VA) estimation module configured to generate a VA including the real signal measurements and a plurality of virtual signal measurements that correspond to locations in the VA between the real signal measurements and generate, based on the VA, detection data indicative of the object in the environment.

A method of operating a radar sensor system includes, using an antenna module, generating an array of real signal measurements that correspond to signals transmitted from first antennas arranged on the antenna module, reflected from an object in the environment, and received by second antennas arranged on the antenna module, generating a virtual array (VA) including the real signal measurements and a plurality of virtual signal measurements that correspond to locations in the VA between the real signal measurements, and generating, based on the VA, detection data indicative of the object in the environment.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an example vehicle including radar sensors according to the principles of the present disclosure;

FIG. 2A is an example antenna module;

FIG. 2B is an example signal array corresponding to the antenna module of FIG. 2A;

FIG. 3 illustrates isolation between antenna elements as a function of inter-element separation;

FIG. 4A is an example antenna module according to the principles of the present disclosure;

FIG. 4B is an example signal array corresponding to the antenna module of FIG. 4A according to the principles of the present disclosure;

FIG. 4C is an example virtual planar array (VPA) corresponding to the antenna module of FIG. 4A and the signal array of FIG. 4B according to the principles of the present disclosure;

FIG. 5 is a radar sensor system according to the principles of the present disclosure;

FIGS. 6A and 6B illustrate mean azimuth and elevation angle estimation error according to the principles of the present disclosure;

FIGS. 7A and 7B illustrate antenna gain patterns for azimuth and elevation directions according to the principles of the present disclosure; and

FIG. 8 illustrates steps of a method for generating a VPA according to the principles of the present disclosure.

In the drawings, reference numbers may be reused to identify similar and/or identical elements.

### DETAILED DESCRIPTION

Radar sensors for vehicle safety and autonomous vehicle applications have various performance requirements. Improving performance associated with some requirements may conflict with performance associated with other requirements. For example, detecting smaller objects (i.e., objects having a small Radar signal effective reflection Cross Section, or RCS) at longer detection range coverage may require greater antenna directivity. Increasing antenna directivity further increases angular selectivity (i.e. increases radar image resolution and accuracy). Greater antenna directivity is achieved by increasing an antenna aperture, which conflicts with small sensor size requirements. Consequently, since greater antenna directivity corresponds to narrower antenna beamwidth, detecting smaller objects for wider Field-of-View (FOV) coverage is difficult. Accordingly, there may be uncovered (i.e., “blind”) zones in the vehicle surroundings between radar sensors arranged on the same vehicle.

Conversely, increasing radar FOV coverage reduces blind zones in the vehicle surroundings between radar sensors in a radar sensor network. However, greater FOV coverage is achieved by decreasing the antenna aperture. The antenna aperture can be reduced to increase beamwidth for smaller directivity and to reduce the overall radar sensor size. This improves radar FOV coverage and reduces blind zones in the vehicle surroundings between radar sensors in a radar sensor network. However, since improved FOV coverage is achieved by trading off directivity, detecting smaller objects at longer ranges becomes difficult. Accordingly, antenna design modifications that result in improved performance with respect to FOV coverage may conflict with performance requirements for antenna directivity (i.e. relatively improved gain, resolution and accuracy) and vice versa.

Various methods may be used to mitigate conflicting performance requirements. In one example, a radar sensor system may include one or more antennas configured to implement electronic scanning to provide multiple antenna beams on a same antenna array, increase FOV coverage, and provide a narrow beam for increased sensitivity, resolution, and accuracy. However, electronic scanning in this manner requires discrete phase shifters that increase costs per vehicle and may cause radio losses at some frequencies.

Accordingly, radar sensor systems for vehicles may use multiple antenna array elements and implement monopulse and/or digital beamforming techniques to determine angular positions of detected objects. Performance parameters including, but are not limited to, FOV coverage, resolution, accuracy, and detection artifacts caused by sidelobes are at least partially determined by a total number of antenna elements and inter-element spacing (i.e., spacing between adjacent antenna array elements). For example, antenna array elements may be spaced by a half-wavelength of an operating frequency. Depending on a polarization of the electromagnetic waves, the half-wavelength spacing between antenna array elements may not provide sufficient inter-element isolation.

Insufficient inter-element isolation may cause performance issues including, but not limited to, non-uniform antenna element pattern distortion and an increased sidelobe due to electromagnetic coupling between antenna array elements. These performance issues may introduce both bias to angle estimation errors of detection and detection artifacts (e.g., false detections). Further, half-wavelength inter-element spacing for a given number of antenna array elements may limit the aperture size and the antenna directivity, which in turn reduces detection sensitivity and angular resolution of detection.

Radar sensor systems and methods according to the present disclosure implement a radar sensor network including a virtual planar array (VPA) of antenna elements (i.e., antennas) to increase antenna aperture size and improve isolation. The VPA includes both actual (i.e., physical) antennas and virtual antennas. The VPA increases inter-element spacing between the physical elements (e.g., from one half to one wavelength) to improve isolation and provides the virtual antennas in the spaces between the physical antennas. For example, the increased spacing improves isolation between the physical antennas from 18 decibels (dB) to 26 dB and 30 dB for horizontal and vertical polarization, respectively and increases the horizontal (i.e., x-axis) antenna aperture (e.g., from one and a half to three wavelengths).

Accordingly, the radar sensor systems and methods of the present disclosure improve the isolation to reduce the effects of inter-element coupling on angle estimation accuracy, reduce detection artifacts, and improve directivity and resolution through antenna aperture size increase. In addition, the interelement spacing increase and isolation improvement facilitates the use of electromagnetic polarizations that allow wider FOV coverage while maintaining the desired image resolution, accuracy and directivity.

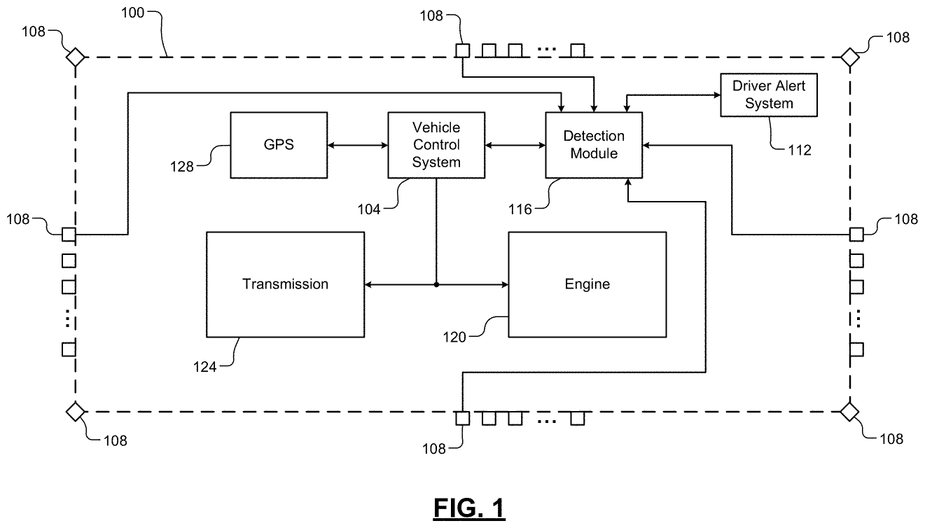

Referring now to FIG. 1, an example vehicle 100 is shown. The vehicle 100 may be a hybrid, non-hybrid, or electric vehicle. In some examples, the vehicle 100 has autonomous or semiautonomous driving capabilities. For example, the vehicle 100 includes a vehicle control system 104 configured to control one or more vehicle functions including, but not limited to, braking, steering, acceleration, transmission (i.e., gear shifting), etc. in accordance with signals received from one or more sensing devices including, but not limited to, radar sensors 108. The radar sensors 108 include, as sub-components, the physical and virtual antennas implemented in a virtual planar array (VPA) of antennas as described below in more detail. Although described herein as a planar array, the virtual array (VA) according to the present disclosure may be implemented as other array configurations, including, but not limited to, a Virtual Uniform Linear Array (VULA), Circular Array (CA), etc.

Alternatively or additionally, the vehicle 100 may include a driver alert system 112 responsive to the signals received from the radar sensors 108 and configured to alert a driver of the vehicle 100 about objects detected in the environment. For example, the driver alert system 112 may be configured to generate audible (e.g., beeping), visual (e.g., flashing lights), and/or haptic (e.g., vibration of interior components of the vehicle) warnings in response to signals indicating potential impact with objects in the environment.

The radar sensors 108 are arranged in a radar sensor network on a front center, front corner, sides, rear center, rear corner, etc. of the vehicle 100 to detect objects (e.g., other vehicles and/or other objects in the environment). The radar sensors 108 transmit signals and receive corresponding from object-reflected signals indicative of the environment in the front, rear, and to the sides of the vehicle 100. A detection module 116 receives the reflected signals and is configured to perform signal processing and other functions related to detection of objects based on the reflected signals. For example, the detection module 116 may be configured to generate images based on the reflected signals, detect and identify features corresponding to objects in the images, provide control signals to the vehicle control system 104 and/or the driver alert system 112 based on the identified features, etc.

The vehicle 100 includes systems including, but not limited to an engine 120 and a transmission 124. The vehicle control system 104 may be configured to selectively control systems of the vehicle 100 via respective control modules (not shown), such as an engine control module, a transmission control module, a braking control module, a steering control module, etc. In some examples, the vehicle 100 includes a global positioning system (GPS) 128 or other type of global navigation satellite system (GNSS) to determine a location of the vehicle 100. In examples where the vehicle 100 has autonomous driving capabilities, the vehicle control system 104 may be configured to provide autonomous control of the vehicle 100 based on vehicle location data received from the GPS 128 in addition to signals received from the radar sensors 108, other sensors (e.g., cameras, Lidar sensors, etc.; not shown), driver inputs, etc.

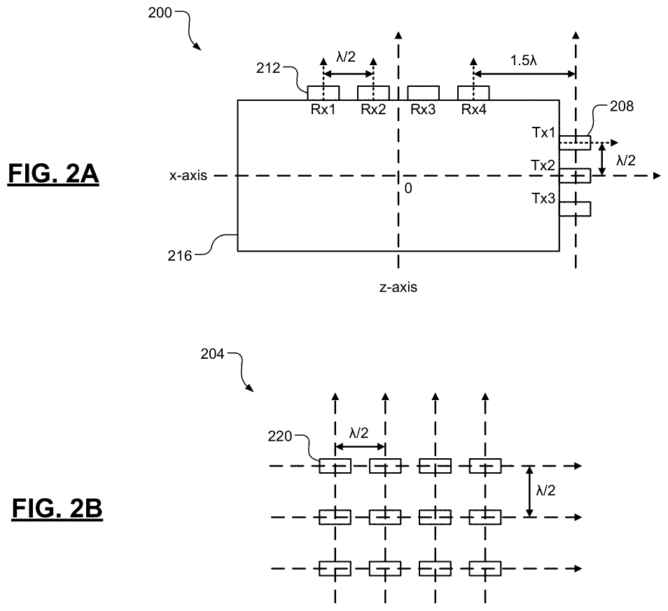

Referring now to FIGS. 2A and 2B, an example antenna module 200 and corresponding signal array 204, respectively, are shown. For example, the antenna module 200 corresponds to the radar sensors 108 of FIG. 1. The antenna module 200 includes respective planar arrays of transmit antennas (i.e., antenna elements, such as patch antenna elements) 208 and receive antennas 212 arranged on the antenna module 200. The antenna module 200 may correspond to a printed circuit board or an integrated circuit (e.g., a radio frequency integrated circuit, or RFIC) 216 including the transmit antennas 208 and the receive antennas 212. The layout of the antenna module 200 as shown in FIG. 2A supports digital scanning of radar targets in both elevation and azimuth directions (i.e., in both z-axis and x-axis directions) using suitable angle finding algorithms (e.g., digital beam forming). The antenna module 200 may correspond to an array of antennas in any suitable arrangement including, but not limited to, a Uniform Linear Array (ULA), Planner Linear Array (PLA), Circular Array (CA), etc. In some examples, the antennas are double slot antennas.

The antenna module 200 is arranged to transmit signals into the environment (i.e., surroundings of the vehicle 100) via the transmit antennas 208 and receive reflected signals (i.e., as reflected from objects in the environment) using the receive antennas 212. Although three of the actual (i.e., real or physical) transmit antennas (e.g., Tx1, Tx2, and Tx3) 208 and four of the actual receive antennas (e.g., Rx1, Rx2, Rx3, and Rx4) 212 are shown, each array of transmit and receive antennas on respective ones of the antenna modules 200 may include any suitable number of corresponding antennas (e.g., one transmit antenna and two receive antennas). As shown, spacing between adjacent ones of the transmit antennas 208 and the receive antennas 212 (i.e., inter-element spacing in both horizontal and vertical directions) is one half-wavelength (½λ) of an operating frequency.

The signal array 204 represents an equivalent array of signal measurements 220 corresponding to signals transmitted and received (i.e., as reflected by a target object) by respective pairs of the transmit antennas 208 and the receive antennas 212. In other words, each of the signal measurements 220 corresponds to transmit/receive antenna pair comprising a different pair of the transmit antennas 208 and the receive antennas 212. For example, the signal measurements 220 in a top row of the array 204 correspond to transmit/receive antenna pairs Tx1/Rx1, Tx1/Rx2, Tx1/Rx3, and Tx1/Rx4 (i.e., representing a signal transmitted from Tx1 and received by Rx1, Rx2, Rx3, and Rx4). The signal measurements 220 in the top row of the array 204 may be referred to as “real” antennas since these measurements correspond to pairs of actual antennas (Tx1/Rx1, Tx1/Rx2, etc.)

Conversely, the signal measurements 220 in a middle row of the array 204 correspond to transmit/receive antenna pairs Tx2/Rx1, Tx2/Rx2, Tx2/Rx3, and Tx2/Rx4 and the signal measurements 220 in a bottom row of the array 204 correspond to transmit/receive antenna pairs Tx3/Rx1, Tx3/Rx2, Tx3/Rx3, and Tx3/Rx4. In other words, the signal measurements 220 in the middle and bottom rows of the array 204 correspond to synthesized or synthetic antennas that reuse Rx1, Rx2, Rx3, and Rx4 in respective pairs with Tx2 and Tx3. Accordingly, the array 204 provides a three-by-four data matrix of equivalent array signal measurements.

The layout of the transmit antennas 208 and the receive antennas 212 on the antenna module 200 may be constrained by performance requirements related to inter-element spacing. For example, half-wavelength or less spacing may be required to provide unambiguous object location estimation but also may limit performance parameters such as detection sensitivity, angular resolution, accuracy as result of limited aperture size and insufficient inter-element isolation.

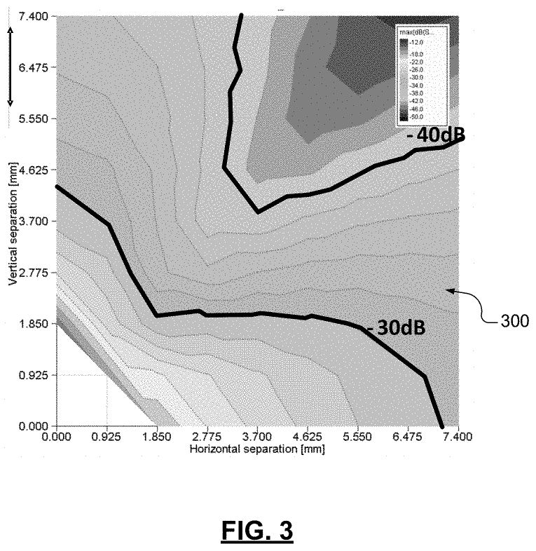

Referring now to FIG. 3, isolation (in decibels dB) 300 between antenna elements as a function of inter-element separation (i.e., spacing) for an example operating frequency band of 77 GHz is shown. As vertical and/or horizontal separation increases, isolation 300 increases accordingly and correspondingly reduces electromagnetic coupling. For example, at half-wavelength spacing, isolation is less than 18 dB, which may not be sufficient to minimize electromagnetic coupling and associated performance errors, such as angular bias detection errors.

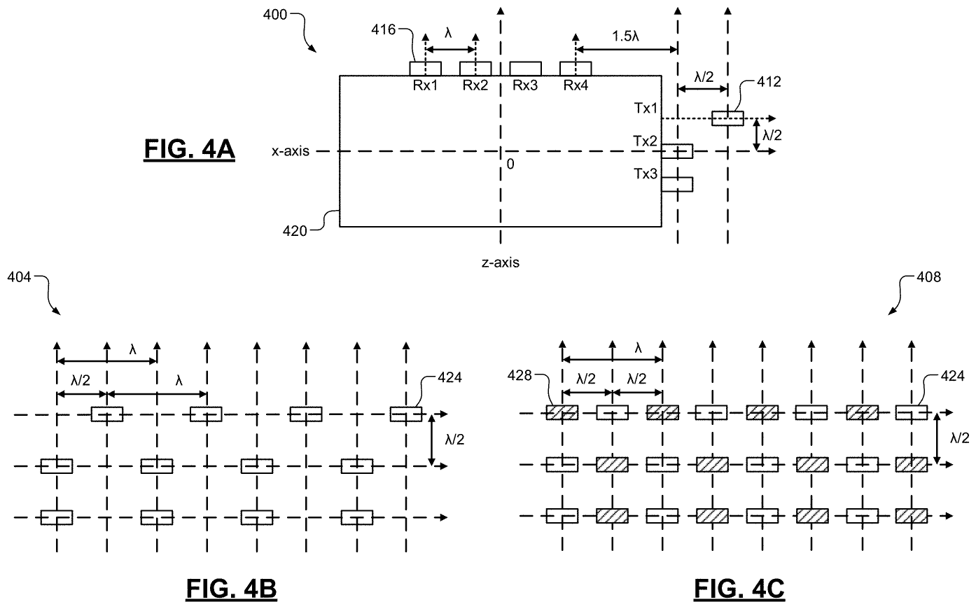

Referring now to FIGS. 4A, 4B, and 4C, an example antenna module 400, corresponding signal array 404, and virtual planar array (VPA) 408, respectively, are shown. For example, the antenna module 400 includes respective planar arrays of transmit antennas (i.e., antenna elements, such as patch antenna elements) 412 and receive antennas 416 arranged on the antenna module 400. The antenna module 400 may correspond to a printed circuit board or an integrated circuit (e.g., an RFIC) 420 including the transmit antennas 412 and the receive antennas 416. As shown, the antenna module 400 includes three of the actual transmit antennas (e.g., Tx1, Tx2, and Tx3) 412 and four of the actual receive antennas (e.g., Rx1, Rx2, Rx3, and Rx4) 416.

Generally, the transmit antennas 412 are configured to transmit while connected to transmitter subcomponents of a transceiver while the receive antennas are configured to receive while connected to receiver subcomponents of a transceiver. Conversely, in some examples, the transmit antennas 412 and/or the receive antennas 416 may be configured to switch functionality. For example, the transmit antennas 412 may be configured to selectively operate as receive antennas (i.e., connect to receiver subcomponents of the RFIC 420) while the receive antennas 416 may be configured to selectively operate as transmit antennas (i.e., connect to transmit subcomponents of the RFIC 420).

In this example, spacing (e.g., vertical spacing in a z-axis direction) between adjacent ones of the transmit antennas 412 is one half-wavelength (½λ) of an operating frequency. Conversely, spacing (e.g., horizontal spacing in an x-axis direction) between the receive antennas 212 is one full wavelength (A) of an operating frequency. Further, a top one of the transmit antennas 412 is offset, in the horizontal, x-axis direction, from others of the transmit antennas 412. For example, as shown, the top one of the transmit antennas 412 is offset by one half-wavelength (½λ).

Accordingly, the increased inter-element spacing between the receive antennas 416 improves antenna aperture size and isolation. For example, the increased spacing improves isolation between the physical antennas from 18 decibels (dB) to 26 dB and 30 dB for horizontal and vertical polarization, respectively and increases the horizontal (i.e., x-axis) antenna aperture (e.g., from one and a half to three wavelengths). Further, while the inter-element spacing in the vertical direction between the transmit antennas 412 remains at one half-wavelength, offsetting the top one of the transmit antennas 412 by one half-wavelength improves isolation with respect to the immediately adjacent (i.e., middle) one of the transmit antennas 412 by more than 10 dB (i.e. from 18 dB to 30 dB). In some examples, selected ones of the transmit antennas 412 (e.g., the middle and bottom transmit antennas 412) may be configured to transmit at different times, such as in a time-division multiple access (TDMA) scheme.

As shown in FIG. 4B, the signal array 404 represents an equivalent array of signal measurements 424 corresponding to signals transmitted and received (i.e., as reflected by a target object) by respective pairs of the transmit antennas 412 and the receive antennas 416. In other words, each of the signal measurements 424 corresponds to a transmit/receive antenna pair comprising a different pair of the actual transmit antennas 412 and the actual receive antennas 416. For example, the signal measurements 424 in a top row of the array 404 correspond to real transmit/receive antenna pairs Tx1/Rx1, Tx1/Rx2, Tx1/Rx3, and Tx1/Rx4 (i.e., representing a signal transmitted from Tx1 and received by Rx1, Rx2, Rx3, and Rx4). Conversely, the signal measurements 424 in a middle row of the array 404 correspond to synthetic transmit/receive antenna pairs Tx2/Rx1, Tx2/Rx2, Tx2/Rx3, and Tx2/Rx4 and the signal measurements 424 in a bottom row of the array 404 correspond to synthetic transmit/receive antenna pairs Tx3/Rx1, Tx3/Rx2, Tx3/Rx3, and Tx3/Rx4.

Inter-element spacing in the horizontal (x-axis) direction between the signal measurements 424 is one full wavelength due to the spacing of the physical receive antennas 416. Conversely, inter-element spacing in the vertical (z-axis) direction between the measurements 424 is one half-wavelength. The measurements 424 in a top row of the array 404 are shifted by one half-wavelength relative to middle and bottom rows due to the horizontal offset of the top one of the transmit antennas 412.

As shown in FIG. 4C, the VPA 408 is generated to include both actual (i.e., physical) antennas and virtual antennas. For example, the VPA 408 includes the signal measurements 424 corresponding to the same transmit/receive antenna pairs as in the signal array 404 and virtual signal measurements 428 corresponding to pairs of virtual antennas. The virtual signal measurements 428 are inserted into spaces between the signal measurements 424. In other words, the virtual signal measurements 428 are provided in the spaces created by increasing the spacing between the signal measurements 424 and shifting the top row of the signal array 404 by one half-wavelength.

In this manner, the three-by-four data matrix of signal measurements 424 is converted into a three-by-eight data matrix including both the signal measurements 424 and the virtual signal measurements 428 having one half-wavelength spacing in both the horizontal and vertical directions. Antenna responses (e.g., including signal amplitudes and phases of the virtual signal measurements 428) corresponding to the respective virtual antennas are calculated using the signal measurements 424 of neighboring ones of the signal measurements 424 as described below in more detail. For example, the virtual signal measurements 428 are calculated using one or more suitable complex interpolation and estimation techniques. The three-by-eight data matrix of the VPA 408 may then be used to digitally scan radar targets in the elevation (z-axis) and azimuth (x-axis) directions. Accordingly, the half-wavelength spacing between antenna elements in the VPA 408 facilitates the resolution of ambiguity that may be caused by the one-wavelength spacing in the physical antenna layout 400 and the equivalent signal array measurements 404 to improve inter-element isolation and decrease electromagnetic coupling.

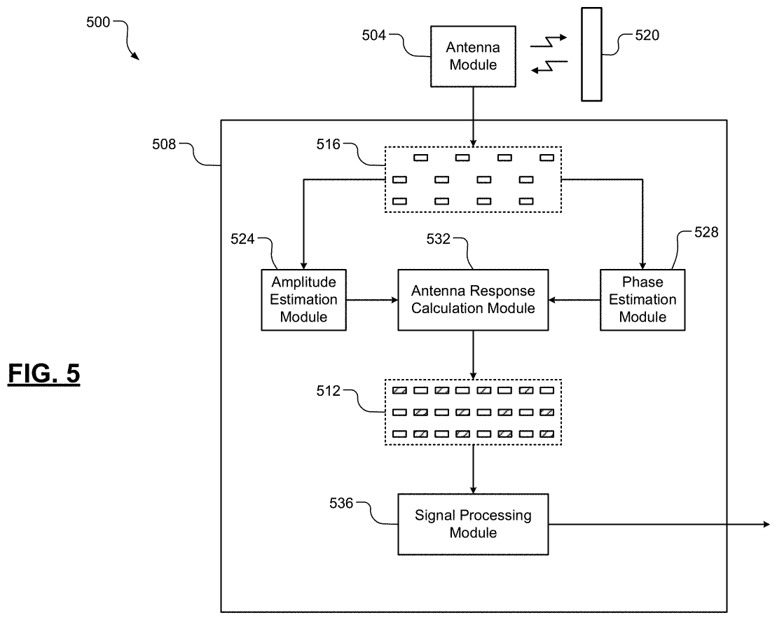

Referring now to FIG. 5, an example radar sensor system 500 according to the principles of the present disclosure includes a network of a plurality of antenna modules 504 (e.g., corresponding to the radar sensors 108 and/or the antenna module 400 arranged on surfaces and/or interior of the vehicle 100) each including an array of transmit antennas and receive antennas as described above. The radar sensor system 500 includes a VPA estimation module 508 configured to calculate a VPA 512 using a signal array 516 as described below in more detail.

The antenna module 504 directs transmit signals at a radar target (e.g., an object in a FOV of the antenna module 504) 520. The antenna module 504 receives reflected signals corresponding to the transmit signals as reflected from the target 520. The antenna module 504 provides the reflected signals (e.g., as signal measurements of the signal array 516) to the VPA estimation module 508.

The signal measurements are respectively provided to an amplitude estimation module 524 and a phase estimation module 528. The amplitude estimation module 524 calculates amplitudes of respective virtual signal measurements (e.g., corresponding to the virtual signal measurements 428) based on neighboring ones of the signal measurements of the signal array 516. For example, the amplitude estimate module 524 is configured to calculate the amplitudes of the virtual signal measurements using a suitable interpolation process (e.g., linear interpolation, non-linear (e.g., polynomial) interpolation, etc.). Similarly, the phase estimation module 528 is configured to calculate (e.g., interpolate) respective phases of the virtual signal measurements based on the neighboring ones of the signal measurements of the signal array 516.

The calculated amplitudes and phases of the virtual signal measurements are provided to an antenna response calculation module 532. The antenna response calculation module 532 is configured to calculate antenna responses including the calculated amplitudes and phases corresponding to the respective virtual antennas. For example, the antenna response calculation module 532 combines the calculated amplitudes and phases to generate respective virtual signal measurements of the VPA 512.

The antenna response calculation module 532 provides the VPA 512 to a signal processing module 536. The signal processing module 536 is configured to process the real and virtual signal measurements in the VPA 512 to generate detection data corresponding to the reflected signals. For example, the signal processing module 536 is configured to implement one or more calibration and/or angle finding algorithms (e.g., beamforming) to generate detection data indicating objects, such as the object 520, in the environment. The signal processing module 536 outputs the detection data to the detection module 116, which is configured to generate images, detect and identify features corresponding to objects in the images, provide control signals to the vehicle control system 104 and/or the driver alert system 112 based on the identified features, etc. based on the detection data.

In this manner, the VPA estimation module 508 generates detection data using signal measurements corresponding to actual transmit/receive antenna pairs (i.e., as provided via the signal array 516) as well as virtual signal measurements corresponding to virtual antenna pairs (i.e., as calculated in the VPA 512). Accordingly, isolation between actual physical antenna elements is improved due to the increased inter-element spacing. Further, the increased antenna aperture size improves electromagnetic polarization performance, which correspondingly improves FOV coverage, image resolution, angle estimation accuracy, detection sensitivity, and false alarm rates.

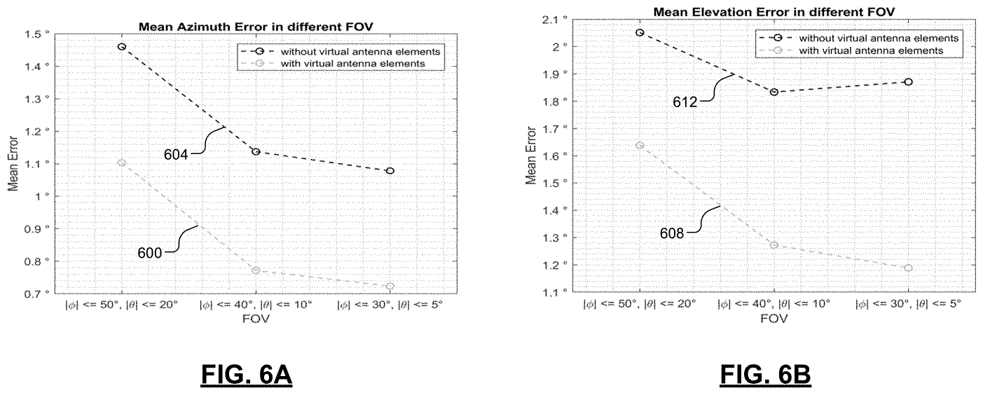

For example, as shown in FIG. 6A, a mean azimuth angle estimation error 600 for the radar sensor system 500 using the VPA 512 is significantly reduced with respect to a mean azimuth angle estimation error 604 for a radar sensor system that does not use the virtual antenna elements according to the present disclosure. Similarly, as shown in FIG. 6B, a mean elevation angle estimation error 608 for the radar sensor system 500 using the VPA 512 is significantly reduced with respect to a mean elevation angle estimation error 612 for a radar sensor system that does not use the virtual antenna elements according to the present disclosure.

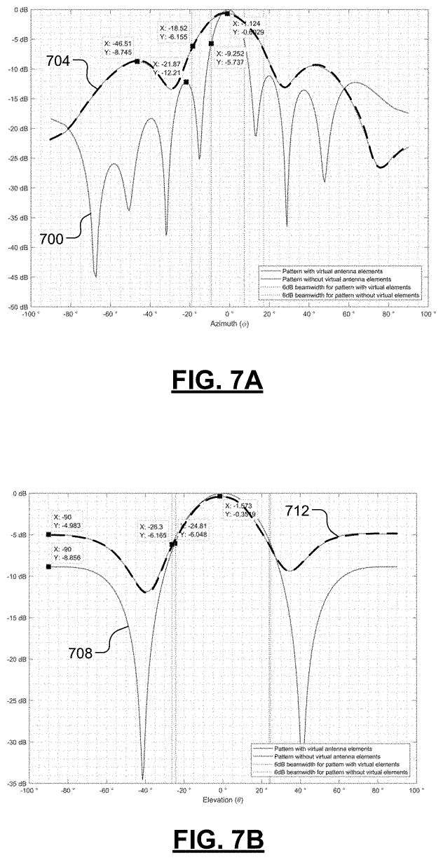

FIG. 7A shows an example azimuth antenna pattern 700 for the radar sensor system 500 and an azimuth antenna pattern 704 for a radar sensor system that does not use the virtual antenna elements according to the present disclosure. FIG. 7B shows an example elevation antenna pattern 708 for the radar sensor system 500 and an elevation antenna pattern 712 for a radar sensor system that does not use the virtual antenna elements according to the present disclosure. As shown in both FIGS. 7A and 7B, the antenna patterns for the VPA 512 provide improved directivity and resolution and decreases the false alarm rate as a result of higher directivity, narrower beamwidth, and lower sidelobe levels relative to the patterns generated without the VPA 512.

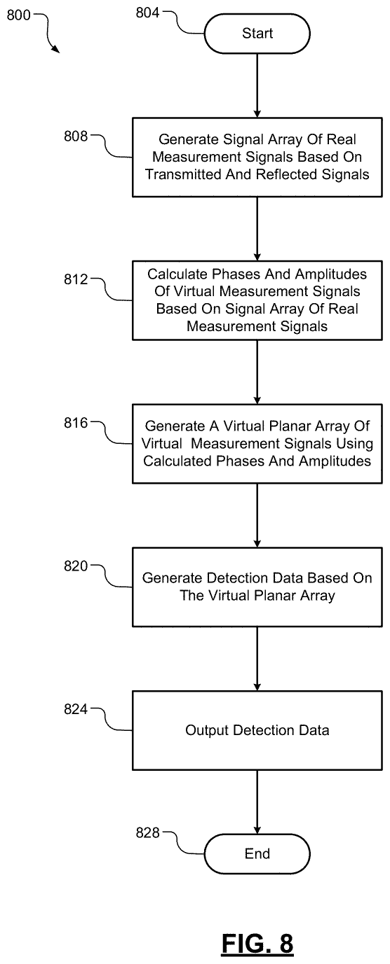

Referring now to FIG. 8, an example method 800 for generating a VPA according to the present disclosure begins at 804. At 808, the method 800 (e.g., the antenna module 504) generates a signal array of real measurement signals based on transmitted and reflected signals. At 812, the method 800 (e.g., amplitude estimation module 524 and the phase estimation module 528) calculates respective phases and amplitudes of virtual measurement signals using the signal array of measurement signals. For example, the method 800 interpolates the measurement signals of the signal array to calculate amplitudes and phases of virtual measurement signals corresponding to spaces between physical antenna elements.

At 816, the method 800 (e.g., the antenna response calculation module 532) generates a VPA (e.g., the VPA 512 based on the calculated amplitudes and phases of the virtual measurement signals). At 820, the method 800 (e.g., the signal processing module 536) generates detection data based on the VPA. At 824, the method 800 outputs the detection data (e.g., to the detection module 116) to generate images and detect and identify features corresponding to objects in the images for controlling the vehicle 100. The method 800 ends at 828.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A radar sensor system, comprising:
an antenna module configured to generate an array of real signal measurements, wherein the real signal measurements correspond to signals transmitted from first antennas arranged on the antenna module, reflected from an object in the environment, and received by second antennas arranged on the antenna module; and
a virtual array (VA) estimation module configured to
generate a VA including the real signal measurements and a plurality of virtual signal measurements, wherein the virtual signal measurements correspond to locations in the VA between the real signal measurements, and
generate, based on the VA, detection data indicative of the object in the environment.

2. The radar sensor system of claim 1, wherein the first antennas correspond to transmit antennas having a first spacing and the second antennas correspond to receive antennas having a second spacing greater than the first spacing.

3. The radar sensor system of claim 2, wherein the first spacing is one half-wavelength of an operating frequency of the first antennas and the second spacing is greater than one half-wavelength of the operating frequency.

4. The radar sensor system of claim 2, wherein the first spacing is one half-wavelength of an operating frequency of the first antennas and the second spacing is one full wavelength of the operating frequency.

5. The radar sensor system of claim 2, wherein the first spacing corresponds to spacing in a vertical direction and the second spacing corresponds to spacing in a horizontal direction.

6. The radar sensor system of claim 5, wherein the first antennas include at least one antenna of the first antennas offset in the horizontal direction from others of the first antennas.

7. The radar sensor system of claim 1, wherein, to generate the VA, the VA estimation module is configured to calculate respective amplitudes and phases of the virtual signal measurements based on the real signal measurements.

8. The radar sensor system of claim 7, wherein the VA estimation module is configured to combine the calculated amplitudes and phases to determine antenna responses of virtual antennas arranged on the antenna module.

9. The radar sensor system of claim 8, wherein the VA estimation module includes an amplitude estimation module configured to calculate the respective amplitudes, a phase estimation module configured to calculate the respective phases, and an antenna response calculation module configured to combine the calculated amplitudes and phases.

10. The radar sensor system of claim 1, further comprising a signal processing module configured to generate the detection data.

11. The radar sensor system of claim 10, wherein the antenna module corresponds to an antenna array, and wherein the radar sensor system further comprises a plurality of the antenna arrays.

12. The radar sensor system of claim 11, wherein the plurality of the antenna arrays includes at least one of transmit double slot antennas and receive double slot antennas.

13. The radar sensor system of claim 1, further comprising a vehicle control system configured to control at least one function of a vehicle based on the detection data as generated by the radar sensor system.

14. The radar sensor system of claim 1, further comprising a driver alert system configured to generate an alert for a driver of a vehicle based on the detection data as generated by the radar sensor system.

15. The radar sensor system of claim 1, wherein the VA corresponds to at least one of a virtual planar array (VPA), a Virtual Uniform Linear Array (VULA), and a Circular Array (CA).

16. A method of operating a radar sensor system, the method comprising:
using an antenna module, generating an array of real signal measurements, wherein the real signal measurements correspond to signals transmitted from first antennas arranged on the antenna module, reflected from an object in the environment, and received by second antennas arranged on the antenna module;
generating a virtual array (VA) including the real signal measurements and a plurality of virtual signal measurements, wherein the virtual signal measurements correspond to locations in the VA between the real signal measurements; and
generating, based on the VA, detection data indicative of the object in the environment.

17. The method of claim 16, further comprising providing a first spacing between the first antennas, wherein the first antennas correspond to transmit antennas, and providing a second spacing greater than the first spacing between the second antennas, wherein the second antennas correspond to receive antennas.

18. The method of claim 17, wherein the first spacing is one half-wavelength of an operating frequency of the first antennas and the second spacing is one full wavelength of the operating frequency.

19. The method of claim 17, wherein the first spacing corresponds to spacing in a vertical direction and the second spacing corresponds to spacing in a horizontal direction.

20. The method of claim 19, further comprising providing an offset in the horizontal direction between at least one antenna of the first antennas from others of the first antennas.

21. The method of claim 16, further comprising calculating respective amplitudes and phases of the virtual signal measurements based on the real signal measurements and combining the calculated amplitudes and phases to determine antenna responses of virtual antennas arranged on the antenna module.

22. The method of claim 16, further comprising at least one of:
controlling at least one function of a vehicle based on the detection data; and
generating an alert for a driver of a vehicle based on the detection data.
